(19) United States
(12) Patent Application Publication
(10) Pub. No.: US 2015/0312316 A1
(43) Pub. Date: Oct. 29, 2015

(54) Method of establishing a connection transmitting messages and controlling users behavior in an information system including the Internet using the web interface

(71) Applicants: Lioudmila Lunkevich Dyer, Davenport, FL (US); Sergey Ilich Leontyev, Oviedo, FL (US); Victor Konstantinovich Sibirsky, Moscow (RU)

(72) Inventors: Lioudmila Lunkevich Dyer, Davenport, FL (US); Sergey Ilich Leontyev, Oviedo, FL (US); Victor Konstantinovich Sibirsky, Moscow (RU)

(21) Appl. No.: 14/120,212

(22) Filed: Apr. 24, 2014

(51) Int. Cl. H04L 29/08; G06F 3/0481

(52) U.S. Cl. CPC H04L 67/025; H04L 67/141; H04L 67/10; G06F 3/0481

(57) ABSTRACT

Method, apparatus and computer software product are intended for the field of computer technology, specifically interaction between individual users and businesses.

This method allows the network provider to use hidden management of network users. Using this method, the network provider guides and controls the location of the web interface cursor.

The position of the cursor is forcibly fixed at a given coordinate of the web interface. It provides desired control (manipulation) over the user, which can be used for the benefit of the web site owner.

Also, a false cursor can be used.

Obviously, it is easier for the user to just click using the provider fixated cursor than to move the cursor to a location desired by the user. As such, the user does not choose where to go, but goes where the owner of the website dictates. This method can be used for touch screens as well.

Use of computer information networks for ensuring social and psychological interaction (household and companionship, business contacts, etc.) between users of such networks/computer system/the automated devices/an electronic device as a way of transmitting messages of various formats is well-known and doesn't require a detailed explanation. For the set characteristics of subjects interacting among themselves listed above, the term “the user” will be applied from now on. Obviously, for such interaction to happen, users' personal computers have to be provided with an appropriate means of interface (in this case, a web interface). For example: input equipment, correctly organized fields on displays, etc. These interfaces enable users' computers to interact with a remote server, which in turn operates the set process of social and psychological interaction. Technologies of similar interfaces interacting with remote servers are known and are actively used in practice. For example: the U.S. Pat. No. 7,340,686 published Apr. 3, 2008 in which the technology of work with the user menu is offered; and U.S. patent 2011175701 published Jul. 21, 2011 in which the user web interface providing production control is described. In turn, the offered invention represents further development of technologies similarly described and will provide a way for interaction between computer network users and the hidden management of computer network users, meaning this invention will apply additional characteristics to social networks in current practice.

The specified technical result is reached using the established connection and transmission of messages between users' personal computers (including portable or wearable computers) and at least one information system. “Users' personal computers” are meant as various types of personal computers, both desktop computers and portable (wearable, mobile) computers, which include laptops, tablets, pocket personal computers, smart phones, communicators, etc. “Information system” represents an Internet or intranet network with appropriate resources. Thus, an information system can represent a national or regional computer network, meaning, a network limited to borders of any state or territory or perhaps an organization's computer network (for example, that of an industrial enterprise, university, or public authority).

At implementation of the offered method of controlling users' activity (in a limited case of one user), the information system in relation to various means and/or resources of this information system is exercised. For control of users' activity, meaning for the personal computer with the set unique network address (IP address) can be used the operations providing control of volume of a traffic, control and statistical processing of requests to remote servers, online time control the Internet, etc., the concrete list of operations of control and their mode is defined proceeding from features of users management of which activity it is necessary. The listed operations of control are carried out in the set temporary mode from the remote computer device, mainly the server connected to this information system. Thus, receive social and psychological characteristics of groups of users/certain users who will be used at further operations of a method.

A network provider (or the website's owner), being guided by a specific goal, using, as required, the obtained data on users' activity in relation to means and/or resources of information system, operates a user's personal computer's cursor position within a web interface according to the teams transferred from the mentioned remote computer device—servers, etc. The cursor in this case is understood as a screen mark, any appearance, indicating a place of emergence of the following symbol/the current position to which situation or operation of the index input equipment (a computer mouse, etc.) concerning the web interface of the user's computer will be applied. Use of functions of the false cursor is also possible. In most cases, the mentioned user's personal computer's cursor position within a web interface forcibly fixes on the set field and/or web interface coordinate, for example, in a field displaying a promotional and/or informational message. As a result, hidden management (manipulation) of the user's activity can be used for the interests of the website's owner, the advertiser, public authority (social advertising, the notification about important events), etc.

As a result, at Internet connection or at the appeal to resources of another information network, the initial address of the user is carried out not to those resources which the user wishes, but with an increasing possibility to resources which the website's owner, (the advertiser, public authority, etc.) is interested in. For personal computers that use touch instead of a cursor as interface navigation, the offered invention could, for example, use a means of highlighting the necessary network functions for the owner, the website, etc. Obviously, it is simple for a user to “click” or touch the field of access to in advance set resource of a network (it can be made also mechanically) without having avoided in this case acquaintance to a necessary resource of information network much more simply, than having visually checked a cursor arrangement, to move it to a position necessary for the user. Thus, the user doesn't choose where to go and goes where the owner of a site wants them to go.

Implementation of the offered way will be similar to organizing buyers' routes in a supermarket, where it only seems to the buyer that he/she moves according to his/her own desire when in reality the route of his/her movement is predetermined, according to the design of a supermarket owner-using data on management of behavior, with the minimum probability of a deviation from a route. Meaning, as stated above, to the user it simple, natural, and logical to click with the left mouse button (or it is even simpler to press the ENTER key) and to pass where the owner of a network deems it necessary; and it is more labor-consuming to conduct the cursor in any other such way seemingly necessary to the user. For a mobile phone, which does not have a mouse or cursor, it is necessary for the owner of a network to specially allocate the space for a “fixed cursor”—e.g., by making it more brightly illuminated, etc. Developing the signal which fixes the cursor in a certain position on the screen can be carried out using available modern programming languages of standard functions on work with the cursor, allowing manipulation without user participation and without increasing traffic volume between the user and a site.

The following are examples of implementation of the offered way of management given by the cursor.

For example, through any search engine (let us call it “SEARCH”) the user wants to find a lawyer. By request (with the corresponding payment) the owner of a network containing address database (let us call it “DATA”) installs the cursor on the option “Looking for Lawyers”, located in the right-top corner. As all advertisers on SEARCH shown by the search of this word, the practical lawyer company (let us call it “LAWYER”) pays a special price for the cursor to be located in the field with LAWYER name. The same option repeats when instead of SEARCH, DATA places the advertisers. The cursor is forcibly fixed on the company LAWYER, which obtains this right for an additional payment. Thus, the user appears on the company website DATA. Additionally, let's say that LAWYER wants the client to receive immediate personal service with a company representative; therefore, the cursor on the website of LAWYER company appears fixed on a window with their “chat” application. Thus, the user looking for a lawyer not only arrived at this LAWYER's site, who paid for the compulsory placement of the cursor, but was also immediately navigated to the LAWYER's “chat” with a representative feature.

Another example of the benefits of using a forced fixed cursor position would obviously be to the owner of a movie website (let us call it “MOVIE”). The advertiser—software developer, wants to increase inflow of clients wishing to pay for more speed on their computers. The advertiser pays a special price for the advertising in competition with other advertisers, and the cursor is installed directly on a visual key “OK” in a window ad for “Make Your PC Run Faster!” Similar advertising can be done for any other company that buys ads on MOVIE.

The ministry of Emergency Situations is concerned with informing website users about the danger of warming—in this case the cursor is fixed on a window of EMERCOM WARNS that provides the maximum number of viewing of this roller with users of this website.

Another example with any charity website (let us call it “CHARITY”): the cursor could be fixed on a place for FUNDRAISING, and then for example on the point $30. This would then provide bigger inflow of funds for the continuing development of this charitable project.

Also, implementation of the offered way will be able to be illustrated in comparison with way of optimization of algorithm of management with concrete object and/or process according to the demand RU2479864. In RU2479864, the example of use of the mouse pointer which is established on function most often used by the user is described so it will save users time. Saving the user's time, a cursor fixated on the most used function according to already collected (or collected and corrected) statistics, brings a positive effect to the website's owner by reducing website traffic, optimizing its operation. Unlike RU2479864, the offered way will increase benefits only for the network's/website's owner (advertiser), as it manipulates the user and aggressively directs the user where the owner prefers, for example on paid advertising. The offered way of manipulating the cursor leads to a situation wherein the user will spend the most of his time viewing an advertiser's message. As a result, the offered way doesn't necessarily push the user, but guides actions that are favorable to the advertiser/owner of the page or website.

Besides manipulating the cursor, this method also manipulates the user by means of the location of the function necessary to the advertiser/owner on the screen, function's color necessary to the advertiser/owner, etc. For example, warm colors would be utilized in the functions deemed necessary by the advertiser/owner, as they attract users more than cool colors. It is possible to manipulate music when passing by the cursor. However management (manipulation) on the basis of fixation of the cursor and/or a place of touch is most effective as optimizes the user's subsequent action from the point of view of a network's owner. If there is no way to manipulate a cursor in a given arrangement, such as in web applications, a false cursor operated by the owner of a network can be presented to the user. The false cursor appears and reacts as the real cursor and is displayed over the user's graphic interface while the real cursor is masked. When using the false cursor, the events generated by a mouse will be caught and emulated. As another way to circumvent this restriction, there would be a web browser plug-in providing access to manipulate the mouse pointer.

Also, the proposed method can be used in private e-mails or messages (e-mail servers, via social network); when the recipient opens an e-mail or message, the cursor will be fixed on the option “Reply” (or any other option preferred by the e-mail sender). In this case, the sender of e-mail has the ability to select from several options and forces the cursor to the position preferred when the recipient opens sender's e-mail.

Thus, this method of transmitting messages between computer users and information systems provides the website's owner with remote management of user activity for use by the advertiser, public authority, etc. The offered approach to management of transmitting messages will be used in various branches of science and technology. The invention described allows experts to formulate and use cutting edge techniques, and these experts will understand and estimate existence of variations, combinations, equivalents of a concrete embodiment, a method, and examples described above. The invention therefore has to be limited not only to the above described options, methods, and examples, but also to all options and methods in any similar framework and spirit of the invention.

What is claimed is:

1. A method for establishing connections and transferring messages to the user's PC, including portable (wearable) computers, connected to at least one information system, providing control over activity, at least one user of the information system, in relation to its devices or resources from a remote computing device, such as a server connected to the devices of the information system; control of the web interface cursor position the above mentioned user's personal computer in accordance with instructions transmitted from the above mentioned remote computing device.

2. The method of claim 1, herein the above mentioned user's PC web interface cursor position is forcibly fixed on a given field or coordinate of the web interface.

3. The method of claim 2, herein the cursor position is forcibly fixed on the field that displays an advertising/informational message.

4. The method of claim 1-3, herein the above mentioned information system is the Internet.

5. The method of claim 1-3, herein the above mentioned information system is a national or regional computer network.

6. The method of claim 1-3, herein the above mentioned information system is an organization's computer network, for example, for an industrial enterprise, university, or public authority.
